(19) United States
(12) Patent Application Publication
(10) Pub. No.: US 2010/0132503 A1
(43) Pub. Date: Jun. 3, 2010

(54) Organ Type Acceleration Pedal

(75) Inventors: Jongho HONG, Seoul (KR); Eunsik Kim, Daegu (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/575,143

(22) Filed: Oct. 7, 2009

(30) Foreign Application Priority Data
Dec. 3, 2008 (KR) 10-2008-0121971

(51) Int. Cl. G05G 1/30

(52) U.S. Cl. 74/560

(57) ABSTRACT

An organ type acceleration pedal may include a pedal pad, a pedal arm, and a mounting bracket, and a foreign material inflow preventing bracket, wherein one end portion of a pedal pad is pivotably supported by a pedal arm coupled to a vehicle body, the other end portion of the pedal pad is integrally formed with a mounting bracket to be mounted to the vehicle body, and a foreign material inflow preventing bracket is detachably assembled with the pedal pad.

### CROSS-REFERENCE TO RELATED APPLICATIONS

The present application claims priority to Korean Application Serial Number 10-2008-0121971, filed on Dec. 3, 2008, the entire contents of which is incorporated herein for all purposes by this reference.

### BACKGROUND OF THE INVENTION

1. Field of the Invention

The present invention relates to an organ type acceleration pedal, particularly an organ type acceleration pedal that can be directly mounted on a vehicle body and selectively equipped with a foreign material inflow preventing bracket.

2. Description of Related Art

According to an organ type pedal in the related art, as shown in FIG. 1, one end of a pedal pad 3 is pivotably connected to a pedal arm 2, which is pivotably supported to a vehicle body by a mounting bracket 1, by a hinge pin 4, and a foreign material inflow preventing bracket 5 is fitted to the other end of pedal pad 3 to prevent inflow of foreign materials into the pivot paths of the pedal pad and the pedal arm, in which foreign material inflow preventing bracket 5 is fastened to the vehicle body by fastening bolts.

In order to connect pedal pad 3 with foreign material inflow preventing bracket 5, as shown in FIG. 2, a long fitting groove 5a is formed in the width direction on foreign material inflow preventing bracket 5 such that the lower end of pedal pad 3 is fitted in fitting groove 5a.

However, according to the above structure of the organ type acceleration pedal in the related art, since the portion where the pedal pad is mounted is formed on the foreign material inflow preventing bracket, this is difficult to be applied to vehicles that do not need a foreign material inflow preventing bracket (e.g. a vehicle with a floor panel having a large inclination angle) or it is required to manufacture a specific foreign material inflow preventing bracket, such that it is difficult to apply the structure to all types of vehicles.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an organ type acceleration pedal that can be commonly applied to acceleration pedals of all the types of vehicles by selectively applying a foreign material inflow preventing bracket to a pedal pad directly mounted to a vehicle body, and makes it possible to assemble the foreign material inflow preventing bracket with the pedal pad in a one-touch way while increasing productivity.

In an aspect of the present invention, one end portion of a pedal pad may be pivotably supported by a pedal arm coupled to a vehicle body, the other end portion of the pedal pad may be integrally formed with a mounting bracket to be mounted to the vehicle body, and a foreign material inflow preventing bracket may be detachably assembled with the pedal pad.

A fitting groove may be formed near to or at a joint portion of the mounting bracket and the pedal pad, and the foreign material inflow preventing bracket may be detachably fitted in the fitting groove.

The fitting groove may include a locking protrusion and the foreign material inflow preventing bracket includes at least a protrusion such that the at least a protrusion of the foreign material inflow preventing bracket is slidably coupled to the fitting groove and locked by the locking protrusion of the fitting groove.

The fitting groove may be formed along a traverse direction of the mounting bracket.

An assembly hole may be formed through the mounting bracket and the mounting bracket may be fastened to the vehicle body by a fastening member therethrough.

An assembly hole may be formed through the foreign material inflow preventing bracket and the foreign material inflow preventing bracket may be fastened to the vehicle body by a fastening member therethrough.

According to the organ type acceleration pedal of the present invention, since the other end of the pedal pad of which one end is directly connected to the pedal arm by the hinge is directly fastened to the vehicle body and the foreign material inflow preventing bracket can be selectively fitted in the fitting groove formed on the rear side of the pedal pad, the organ type acceleration pedal can be applied to all the types of vehicles and it is not required to specifically manufacture a foreign material inflow preventing bracket, even if the types of vehicles are changed. Further, it is possible to easily assemble the foreign material inflow preventing bracket with the pedal pad.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIGS. 1 and 2 are assembly and exploded perspective views of an organ type acceleration pedal according to the related art, respectively.

FIGS. 3 and 4 are assembly and exploded perspective view of an organ type acceleration pedal according to the present invention, respectively.

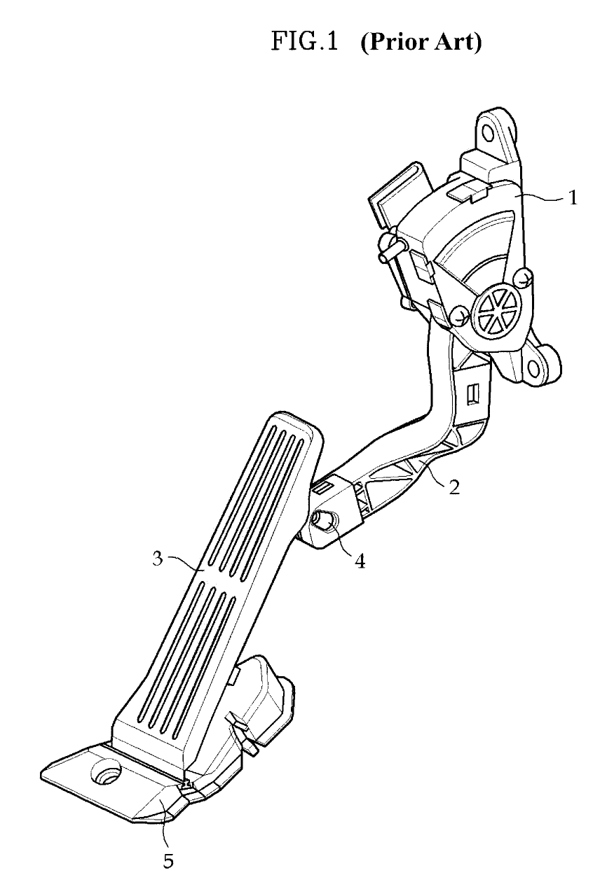

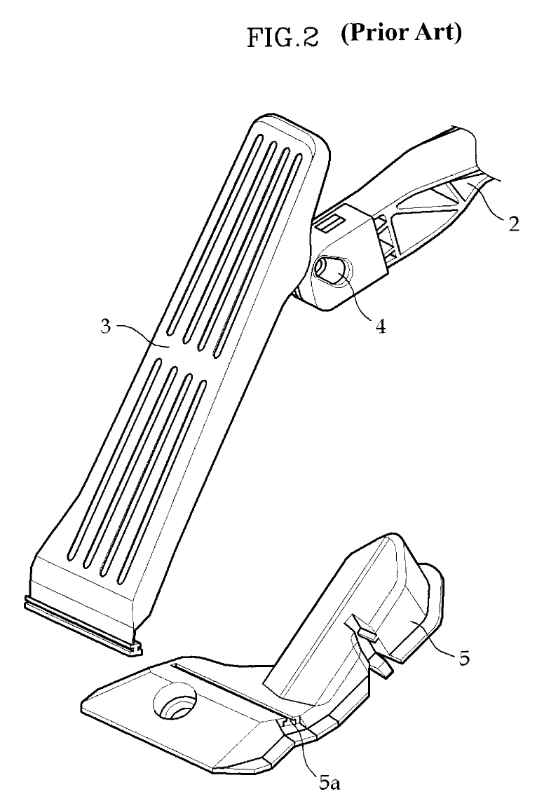

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

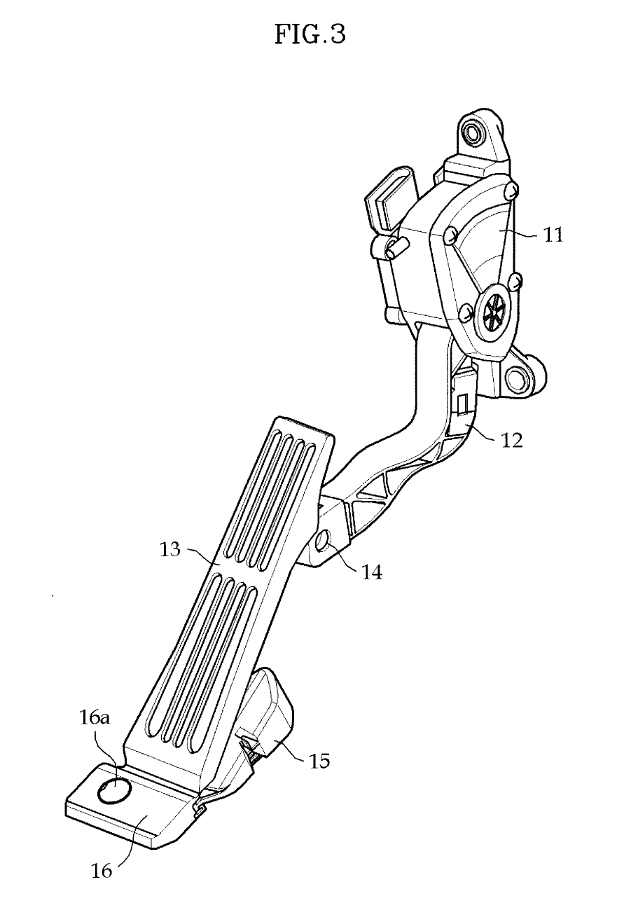

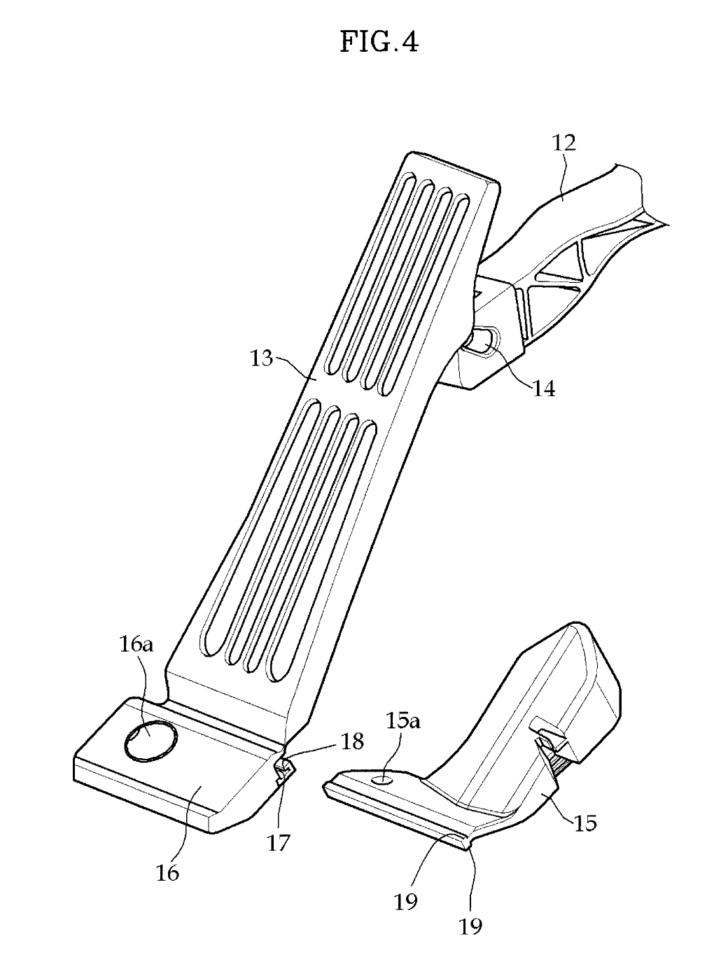

Referring to FIGS. 3 and 4, one end of a pedal pad 13 is pivotably connected to a pedal arm 12, which is pivotably supported to a vehicle body by a mounting bracket 11, by a hinge pin 14, and a foreign material inflow preventing bracket 15 is fitted to the other end of pedal pad 13 to prevent inflow of foreign materials into the pivot paths of pedal pad 13 and the pedal arm 12.

A mounting bracket 16 integrally extends from pedal pad 13 and a fitting groove 17 is formed on the rear surface of the joint of mounting bracket 16 and pedal pad 13, such that foreign material inflow preventing bracket 15 is detachably fitted in fitting groove 17.

In an exemplary embodiment of the present invention, the fitting groove 17 may include a locking protrusion 18 and the foreign material inflow preventing bracket 15 may include at least a protrusion 19. The foreign material inflow preventing bracket 15 may be slidably coupled to the fitting groove 17 and the protrusions 19 may be locked by the locking protrusion 18 of the fitting groove 17.

An assembly hole 16a is formed through mounting bracket 16 to fasten the mounting bracket to the vehicle body using fastening bolts.

Further, an assembly hole 15a is formed through foreign material inflow preventing bracket 15 such that foreign material inflow preventing bracket 15 is fastened together with mounting bracket 16 by a fastening bolt when mounting bracket 16 is fastened to the vehicle body by a fastening bolt.

Therefore, in a vehicle that does not need foreign material inflow preventing bracket 15, for example, a vehicle with a floor panel having a large inclination angle, pedal pad 13 can be directly mounted by mounting bracket 16, or foreign material inflow preventing bracket 15 can be fitted in fitting groove 17, if foreign material inflow preventing bracket 15 is needed. Therefore, the organ type acceleration pedal can be commonly applied to all the types of vehicles, and it is possible to easily maintain foreign material inflow preventing bracket 15, in addition to selectively applying it, if needed.

For convenience in explanation and accurate definition in the appended claims, the term “rear” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An organ type acceleration pedal, wherein one end portion of a pedal pad is pivotably supported by a pedal arm coupled to a vehicle body, the other end portion of the pedal pad is integrally formed with a mounting bracket to be mounted to the vehicle body, and a foreign material inflow preventing bracket is detachably assembled with the pedal pad.

2. The organ type acceleration pedal as defined in claim 1, wherein a fitting groove is formed near to or at a joint portion of the mounting bracket and the pedal pad, and the foreign material inflow preventing bracket is detachably fitted in the fitting groove.

3. The organ type acceleration pedal as defined in claim 2, wherein the fitting groove includes a locking protrusion and the foreign material inflow preventing bracket includes at least a protrusion such that the at least a protrusion of the foreign material inflow preventing bracket is slidably coupled to the fitting groove and locked by the locking protrusion of the fitting groove.

4. The organ type acceleration pedal as defined in claim 2, wherein the fitting groove is formed along a traverse direction of the mounting bracket.

5. The organ type acceleration pedal as defined in claim 4, wherein the fitting groove includes a locking protrusion and the foreign material inflow preventing bracket includes at least a protrusion such that the at least a protrusion of the foreign material inflow preventing bracket is slidably coupled to the fitting groove and locked by the locking protrusion of the fitting groove.

6. The organ type acceleration pedal as defined in claim 1, wherein an assembly hole is formed through the mounting bracket and the mounting bracket is fastened to the vehicle body by a fastening member therethrough.

7. The organ type acceleration pedal as defined in claim 6, wherein an assembly hole is formed through the foreign material inflow preventing bracket and the foreign material inflow preventing bracket is fastened to the vehicle body by a fastening member therethrough.

8. The organ type acceleration pedal as defined in claim 1, wherein an assembly hole is formed through the foreign material inflow preventing bracket and the foreign material inflow preventing bracket is fastened to the vehicle body by a fastening member therethrough.
